(19) United States
(12) Patent Application Publication
(10) Pub. No.: US 2004/0230409 A1
(43) Pub. Date: Nov. 18, 2004

(54) Method for performing social computation

(75) Inventor: Isaac Saias, Cambridge, MA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: NuTech Solutions, Inc.

(21) Appl. No.: 10/868,650

(22) Filed: Jun. 15, 2004

Related U.S. Application Data
(63) Continuation of application No. 09/388,123, filed on Aug. 31, 1999.
(60) Provisional application No. 60/098,590, filed on Aug. 31, 1998.

(51) Int. Cl. G06F 7/60

(52) U.S. Cl. 703/2

(57) ABSTRACT

The present invention relates generally to methods for performing social computation. More specifically, the present invention detects emergent concepts from a plurality of sites by creating an adjacency matrix representing the connectivity among the sites, computing the transpose of the adjacency matrix and computing the nth order eigenvalues of the product of the adjacency matrix and the transpose matrix

### FIELD OF THE INVENTION

The present invention relates generally to methods for performing social computation. More specifically, the present invention detects emergent concepts from a plurality of sites by creating an adjacency matrix representing the connectivity among the sites, computing the transpose of the adjacency matrix and computing the nth order eigenvalues of the product of the adjacency matrix and the transpose matrix.

### BACKGROUND

The main aim in “social computation” is to develop tools enabling the forecasting of the future behavior of a society. Most approaches in forecasting proceed in the following three-stepped approach. One postulates a parameterized dynamics of the underlying system. One then optimizes the choice of parameters to determine these parameters accounting best for the past observations. Finally one uses the calibrated dynamics to forecast future events.

For instance, most predictions done in the business community are based on statistical regressions. In that context, one postulates that the observable y is generated through a process y=ƒ_{λ}(x)+noise: x is the explanatory variable, “noise” is a process with known dynamics and λ is a parameter to be calibrated. Linear regression corresponds to the assumption that “noise” is white, and to the choice of linear functions ƒₓ The white noise assumption leads to mean-square optimization of the parameter: the past X₀ yields a parameter λ₀ all owing the predictions ƒ_{λ}(x).

Standard mathematical dynamical systems also proceed along this three-step approach, as do the modem agent-based models. Even though very different, all these forecasting methods rely on ‘proper” modeling of the underlying system dynamics. Most systems exhibit a chaotic behavior at small scales, so that only “skeletal models that tend to capture generic global dynamics and not microscale behavior” can hope to appropriately capture reality. Finer-scale prediction requires therefore a different approach.

The difference between detection and prediction is often just a matter of available technology. For example, until very recently, a pregnant woman had to await delivery to discover the gender of her child. Inferring this gender was therefore a predictive activity, trying to guess a fact that only future could reveal. Many people had argued that the only forecasting available was to flip a coin (with a small bias). The advent of new probing technology changed fully the paradigm of uncertainty. Now, uncertainty is not to be dynamically revealed, (when one flips the coin, i.e., at delivery), but instead unveiled from a hitherto masked “random state”. (Interestingly enough, the Turing model for random computation also assumes the existence of a hidden random tape consigning all future random flips.)

Many uncertain events are similarly not the product of dynamic random choices, but simply the emergence of facts so far kept “below the level of noise” for lack of appropriate technology. Many social phenomena fall within that level of uncertainty. Their so-called “unpredictability” is in fact more an expression of their complexity then of a genuine random or chaotic phenomenon of nature. The advent of the World Wide Web and the emergence of new, dynamic, very large databases both raise new challenges and offer new possibilities for the acquisition of knowledge. On the one hand, their complexity seems to create new realms of uncertainty and unpredictability: conventional databases were “easy” to query and manipulate; but who can control the World Wide Web and the format of the displayed information? On the other hand, the new linkage of vast domains of knowledge raises the possibility to investigate and corroborate facts that have been mostly disparate thus far.

Accordingly, there exists a need for a method for detecting emergent concepts from a plurality of sites.

### SUMMARY OF THE INVENTION

The present invention presents a method for partitioning that provides both a relevant metric and a set of clusters through an evolutionary learning process.

It is an aspect of the present invention to present a method for detecting at least one emergent concept among a plurality of sites comprising the steps of:

creating at least one adjacency matrix A, said adjacency matrix having a plurality of entries, Aᵢⱼ wherein:

i and j are among said plurality of sites;

Aᵢⱼ=r if said sites, i, j are connected;

Aᵢⱼ=0 otherwise; and

r is a positive number;

computing the transpose matrix A^{T} of said adjacency matrix A;

computing the nth eigenvector X⁽ⁿ⁾ of a matrix product-of said transpose matrix and said adjacency matrix, A^{T} A for determining an authority value of said plurality of sites, wherein n is a natural number.

It is an aspect of the present invention to present a method for detecting at least one emergent concept among a plurality of sites further comprising the steps of computing the nth eigenvector Y⁽ⁿ⁾ of a matrix product of said adjacency matrix and said transpose matrix, A A^{T} for determining a hub value of said plurality of sites.

### BRIEF DESCRIPTION OF THE DRAWINGS

FIG. 1 provides a flow diagram of the method for detecting emergent concepts from a plurality of sites of the present invention.

FIG. 2 discloses a representative computer system in conjunction with which the embodiments of the present invention may be implemented.

### DETAILED DESCRIPTION OF THE PREFERRED EMBODIMENT

The present invention presents methods for detecting emergent concepts from a plurality of sites. Without limitation, many of the following embodiments of these methods are explained in the illustrative contexts of the World Wide Web and intelligence applications. However, it will be apparent to persons of ordinary skill in the art that the aspects of the embodiments of the invention are also applicable in any context where emergent concepts can be detected from a plurality of sites.

The present invention is based on some very recent developments on the analysis of social linked structures as explained in Kleinberg J. (1998). Authoritative Sources in a Hyperlinked Environment. Proceedings of the ACM-SIAM Symposium on Discrete Algorithms (SODA-1998), (“Kleinberg”) the contents of which are herein incorporated by reference. Social linked structures are further described in Gibson D., Kleinberg J. and Raghavan P. (1998), Inferring Web Communities from Link Topology. Proceedings of the 9^{th} ACM Conference on Hypertext and Hypermedia, (“Gibson”) the contents of which are herein incorporated by reference. In dynamic structures such as the World Wide Web, concepts that are semantically related give rise to substructures that are densely linked. For instance, people interested in databases are going to reference each others' pages. This body of related pages is thus giving rise to a denser body of nodes. Conversely, sets of nodes densely related share common topics and thus correspond to some emergent semantic concept. Thus, in dynamic structures like the World Wide Web, the link topology is fundamentally associated to the semantic lexicon expressed collectively. Most of the techniques developed in Kleinberg and Gibson are concerned with the analysis of static structures. In contrast, the present invention extends techniques to linked data-structures that change with time.

Several scenarios from the intelligence contexts indicate the importance of the detection of concepts from linked data-structure that change with time. In most situations where an international event happens seemingly without warning and surprises the monitoring intelligence agencies, forensic analysis reveals that these agencies had possession of critical information, but that this information never “made it to the top” and was left unutilized. Therefore, a mechanism like the present invention that allows agencies to detect important reports out of the morass of information they routinely process is of prime importance. The present invention includes an intranet-based system of information supporting such automatic detection of concepts.

A further example concerns assisting intelligence agencies in the promotion of the internal emergence of critical opinions. The application of the techniques of the present invention to the World Wide Web at large, can help detect and monitor the emergence of new social movements. The beauty of the approach of the present invention is that it is driven externally by the evolution of the World Wide Web, independently of any opinion previously expressed within a monitoring intelligence community.

Use of the techniques of the present invention is generally justified since most “surprising” social events are surprising only because of the inability to read the many dispersed premonitory signals. In actuality, many unrelated individuals notice facts that collectively reinforce each other into a clearer signal. The present invention has a double effect on detection. On the one hand it can “read” the global emergence of signals at levels previously considered to be “below noise level”. On the other hand the present invention will help boost the emergence of important detected concepts by publishing such discoveries.

Existing clustering techniques based on link topology distinguish between authority nodes and hubs. An authority node is a node that is referred to by many other nodes. For example, the 1905 paper by Einstein is an authority on special relativity. A hub node is a node that points to many other nodes. For example, “Yahoo!” is a hub node for the World Wide Web. An authority node is an “important” authority only if it is pointed to by “important” nodes. Conversely, a hub node is an important hub only if points to important authority nodes. This apparently circuitous definition lends itself to a very natural weight diffusion algorithm.

To illustrate the method, assume that one wants to investigate emergent concepts related to Iraq. One first selects a subpart of the World Wide Web representative of almost all concepts related to Iraq. Specifically, one begins with a seed of (for example) 200 often-referenced sites about Iraq, obtained from a standard search engine like Yahoo! or Alta Vista. Next, the method extends to include all sites that are connected to this initial seed. (Actually a bit of pruning is required if too many nodes are connected to that site: think of the site Alta Vista itself!) The graph thus obtained is the graph G over which the rest of the analysis is conducted.

Each node i of G is allocated two values (xᵢ,yᵢ): xᵢ is its authority value, and yᵢ is its hub value. All xᵢ and yᵢ are initialized to 1. We let x⁽⁰⁾ denote the vector of all initial values xᵢ (equal to 1 by definition). Similarly y⁽⁰⁾ is the vector of all initial values yᵢ. The algorithm proceeds in phases. Each phase k has two stages. In stage 1, the algorithm updates in parallel all the authority values, transforming the vector x^{(k-1)} into x^{(k)}. In stage 2 the algorithm updates n parallel all the hub values, transforming the vector y^{(k-1)} into y^{(k)}. Specifically, in phase 1, the algorithm updates each xᵢ to be the sum of all yⱼ for j pointing to i. The algorithm normalizes the x's so that

$${\sum }_{ i}^{} {x}_{i}^{2} = 1.$$

Thus, in this update, the authority-value xᵢ of node i increases if it is referenced by nodes j with high hub value. In stage 2, the algorithm updates each yⱼ to be the sum of all xᵢ for j pointing to i. The algorithm normalizes the y's so that

$${\sum }_{ j}^{} {y}_{j}^{2} = 1.$$

Thus, in this update, the hub-value yⱼ of node j increases if it references nodes i with high authority value. Thus, hub values and authority values re-enforce each other. One easily establishes that this process converges and that the vectors x^{(k)} and y^{(k)} converge to limits X and Y. One shows that X can be directly characterized as being the principal eigenvector of the symmetric matrix A^{T} A, where A is the adjacency matrix of the linked structure; symmetrically, Y is the principal eigenvector of the matrix AA^{T}. Thus, the values i for which Xᵢ, is “big” are “important” authority nodes. Symmetrically, values j for which Yⱼ is “big” are “important” hub nodes.

A major problem with this technique is the problem of diffusion, where, for instance, the original question about Iraq brings sites like Yahoo! or Alta Vista: these sites are connected to basically everyone and thus appear quite often as important sites in the principal eigenvector. This problem is remedied by considering non-principal eigenvectors: one considers the full spectral decomposition of A^{T}A and AA^{T}, (not only the principal directions). Each non-principal eigenvector gives rises to a community of nodes related by a common concept. The justification is the same as for the principal eigenvector. For every n, the n^{th} eigenvector X⁽ⁿ⁾ of A^{T}A reinforces the n^{th} eigenvector of Y⁽ⁿ⁾ of AA^{T}. In more practical terms, the set of sites i for which Xᵢ⁽ⁿ⁾ is “high” form a community of authority nodes that reinforce the community of hub nodes j for which Yᵢ⁽ⁿ⁾ is big.

Simulations establish that this technique performs extremely well at extracting natural concepts from the World Wide Web. It is very robust against variations of the initial seed. The reason is that important hubs and authorities about a subject are by definition reachable from all seed sets of a reasonable size (200 seems to be a reasonable size). In particular, if one considers the World Wide Web to be large in contrast to an intelligence agency's intranet, the technique is very robust against changes of language. Thus, an initial seed coming from an arabic context will provide very similar results as an initial seed coming from an English context. The reason is that important hubs and authorities are reached from any part of the World Wide Web. That is a big plus for intelligence work! The technique is furthermore computationally quite feasible. The reason is that the method hinges on the diagonalisation of the matrices A^{T}A and AA^{T} which are sparse. Accordingly, as is known by those of ordinary skill in the art, there are many efficient iterative methods for performing this task.

The previously described methods apply to the static analysis of a linked topology. The present invention extends these methods to produce a time-varying representation of the concepts of an intelligence intranet or to the World WideWeb. The present invention automatically picks up the emergence of new concepts as they hit a minimal connectivity threshold within the intranet or the World Wide Web. It also posts the result of such searches within the intranet of the intelligence agency. Posting the results showing an embryonic emergent new concept will boost its recognition among other participants, if this concept is expressing a genuine social evolution.

The present invention harnesses the diffusion problem. As previously explained, the problem is that sharply defined queries will tend to “diffuse” away into more general concepts that have already built a minimal connectivity. To use an image as an example, the diffusion problem is similar to the problem encountered by a distant observer trying to pick at night a neighborhood from among all the lights of a city. This distant observer might be able to distinguish a larger neighborhood cluster but would have more difficulty bringing the resolution down to a specific building. The topological approach of the present invention achieves remarkable results by considering large order eigenvectors of the matrices A^{T}A and AA^{T}. Large order eigenvectors such as the 50^{th} non-principal eigenvector do a beautiful job at isolating smaller communities.

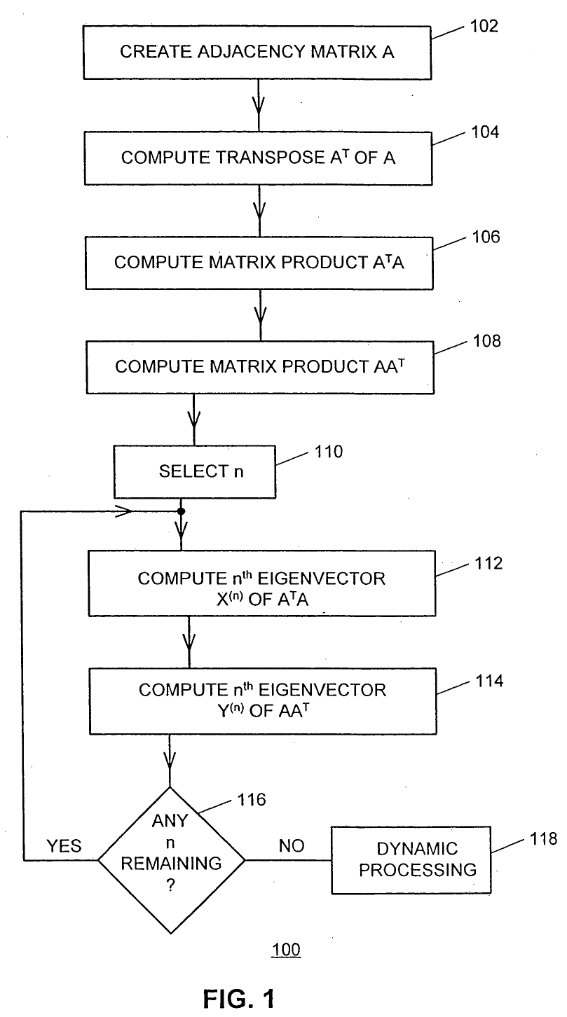

FIG. 1 provides a flow diagram of the method 100 for detecting emergent concepts from a plurality of sites of the present invention. In step 102, the method 100 for detecting emergent concepts creates an adjacency matrix A. In step 104, the method 100 computes the transpose A^{T} of the adjacency matrix A. In steps 106 and 108, the method 100 for detecting emergent concepts computes the matrix products A^{T}A and AA^{T} respectfully.

Next, in step 110, the method 100 of the present invention selects a value for n. Using the value for n selected in step 110, the method 100 for detecting emergent concepts computes the nth order eigenvector A⁽ⁿ⁾of A^{T}A. Similarly, using the same value for n selected in step 110, the method 100 for detecting emergent concepts computes the nth order eigenvector Y⁽ⁿ⁾ of A A^{T}. In step 116, the method 100 determines whether there are any remaining values of n. If step 116 determines that there are values of n remaining, then control proceeds to step 110 where the method selects another value for n. If step 116 determines that there are no values of n remaining, control proceeds to-step 118. In step 118, the method 110 will modify or recreate the adjacency matrix A to dynamically reflect connectivity changes among the sites. Connectivity changes include the addition of connections between sites, the removal of connections between sites and changes in connection strength. If the adjacency matrix A is modified control proceeds to step 104 in order to begin computing a new set of eigenvalues.

In an alternate embodiment, the present invention combines the purely topological techniques with a mix of other techniques to control that diffusion. For example, text based techniques allocate a lexical score on communities of nodes containing certain terms. This technique can be used iteratively to refine the graph over which research is performed. Instead of blindly selecting a seed of initial nodes (provided, say, by a standard search engine) and expending it to all the neighboring nodes, this technique selectively constructs the graph by focusing it on the subject at hand. In an alternate embodiment, the present invention also utilizes latent semantic indexing as described in Deerwester, Dumais, Landauer, Furnas and Harshman. (1990). Indexing by latent semantic analysis. Journal of the American Society for Information Science. 41(1990), 391-407, the contents of which are herein incorporated by reference.

In another alternate embodiment, instead of using a pure adjacency matrix A whose entries are either 0 or 1 (Aᵢⱼ=1 if nodes i and j are connected), the present invention sets Aᵢⱼ to different values to account for the strength of the connection. That strength can be evaluated with different filters. For instance, Aᵢⱼ might be higher is the link was created more recently.

The present invention further includes “time series” analysis tools, where the time series does not track the evolution of scalar values. Instead, the time series tracks the evolution of Web-topological communities. In particular, the growth of new communities can be very instructive and reveal the emergence of new social phenomena.

Further, the detection algorithm of the present invention provides intelligence reports accessible to intelligence participants. The present invention posts these reports on the intranet. The reports themselves become nodes that are linked to the nodes that they have inferred to be linked. Intelligence participants will be able to “answer” these reports by linking to them if they find them worthwhile. Thus, a report would become a catalyst for crystallization of the intelligence, bringing to the fore opinions consensual among a smaller intelligence sub-community.

As mentioned above, the present invention is not restricted to the World Wide Web. Instead, the techniques of the present invention also apply to any linked structure. In particular, one can apply these techniques to monitor the communication patterns of people under surveillance. For instance, one could link two people having communicated within a t=24 hour time window. The spectral techniques described above would allow to pick up communities having tight communication rapport over that period of time. That might be extremely useful to detect the dynamic emergence of suspicious activities. As communities have different “relaxation” times, the present invention investigates appropriate choices for the time-window t. For instance, financial communities exchange information faster then other communities. Furthermore, after appropriate calibration of that time t, a dynamic analysis would allow the pick up and acceleration of the communication pattern, thus dynamically raising alarms and triggering other investigation methods.

Standard fraud detection is another application of the link analysis of the present invention. For example, modem computer fraud involves many talented agents, whose individual behavior is apparently normal, but whose collective behavior readily indicates collusion or fraud. Linking these people has been a major intelligence task involving the performance of mostly ad-hoc statistical methods or standard word of mouth. The dynamical linking procedures of the present invention zoom into linking patterns that have been safely ensconced below the detectable detection levels of law-enforcing agencies.

The present invention has hardware and software computational requirements because it requires the diagonalization of very large adjacency matrices. On the hardware side, the implementation of such spectral methods require somewhat powerful computing resources. Preferably, the present invention executes on a network of computers as such networks are very powerful and relatively cheap.

On the software side, the present invention requires well-established iterative methods for the singular value decomposition of sparse matrices. As is known by those of ordinary skill in the art, highly optimized code is available to perform this task.

For efficient data processing and archival, it is best to maintain a local copy of the World Wide Web sites over which analysis is to be performed. If not, as mentioned in Kleinberg, the time required to fetch the html-source to construct the base set for the analysis is the greater time bottleneck. Thus, we are thus faced with the standard time/space trade-off.

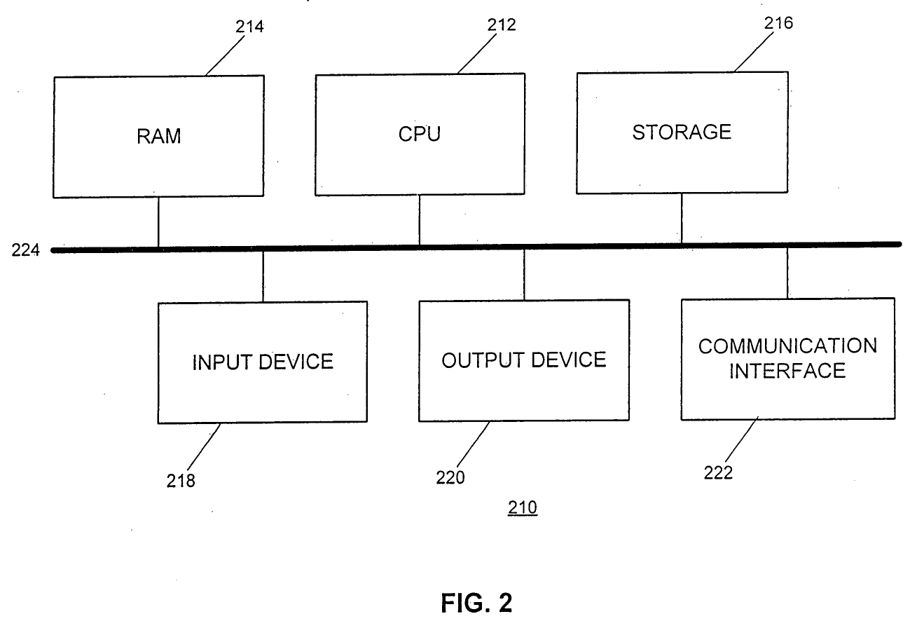

FIG. 2 discloses a representative computer system 210 in conjunction with which the embodiments of the present invention may be implemented. Computer system 210 may be a personal computer, workstation, or a larger system such as a minicomputer. However, one skilled in the art of computer systems will understand that the present invention is not limited to a particular class or model of computer.

As shown in FIG. 2, representative computer system 210 includes a central processing unit (CPU) 212, a memory unit 214, one or more storage devices 216, an input device 218, an output device 220, and communication interface 222. A system bus 224 is provided for communications between these elements. Computer system 210 may additionally function through use of an operating system such as Windows, DOS, or UNIX. However, one skilled in the art of computer systems will understand that the present invention is not limited to a particular configuration or operating system.

Storage devices 216 may illustratively include one or more floppy or hard disk drives, CD-ROMs, DVDs, or tapes. Input device 218 comprises a keyboard, mouse, microphone, or other similar device. Output device 220 is a computer monitor or any other known computer output device. Communication interface 222 may be a modem, a network interface, or other connection to external electronic devices, such as a serial or parallel port

While the above invention has been described with reference to certain preferred embodiments, the scope of the present invention is not limited to these embodiments. One skill in the art may find variations of these preferred embodiments which, nevertheless, fall within the spirit of the present invention, whose scope is defined by the claims set forth below.

1. A method for detecting at least one emergent concept among a plurality of sites comprising the steps of:
creating at least one adjacency matrix A, said adjacency matrix having a plurality of entries, Aᵢⱼ wherein:
i and j are among said plurality of sites;
Aᵢⱼ=r if said sites, i, j are connected;
Aᵢⱼ=0 otherwise; and
r is a positive number;
computing the transpose matrix A^{T} of said adjacency matrix A;
computing the nth eigenvector N⁽ⁿ⁾ of a matrix product of said transpose matrix and said adjacency matrix, A^{T} a for determining an authority value of said plurality of sites, wherein n is a natural number.

2. A method for detecting at least one emergent concept among a plurality of sites as in claim 1 comprising the step of:
computing the nth eigenvector Y⁽ⁿ⁾ of a matrix product of said adjacency matrix and said transpose matrix, A A^{T} for determining a hub value of said plurality of sites.

3. A method for detecting at least one emergent concept among a plurality of sites as in claim 1 wherein said positive number r represents the strength of said connection between said sites.

4. A method for detecting at least one emergent concept among a plurality of sites as in claim 1 wherein said natural number n is one.

5. A method for detecting at least one emergent concept among a plurality of sites as in claim 4 wherein said nth eigenvector X⁽ⁿ⁾ is a principal eigenvector of said product A^{T} A.

6. A method for detecting at least one emergent concept among a plurality of sites as in claim 4 wherein said nth eigenvector Y⁽ⁿ⁾ is a principal eigenvector of said product A A^{T}.

7. A method for detecting at least one emergent concept among a plurality of sites as in claim 1 wherein said natural number n is greater than one.

8. A method for detecting at least one emergent concept among a plurality of sites as in claim 1 wherein said nth eigenvector X⁽ⁿ⁾ is a principal eigenvector of said product A^{T} A.

9. A method for detecting at least one emergent concept among a plurality of sites as in claim 1 wherein said nth eigenvector Y⁽ⁿ⁾ is a principal eigenvector of said product A^{T} A.

10. Computer executable software code stored on a computer readable medium, the code for detecting at least one emergent concept among a plurality of sites, the code comprising:
code to create at least one adjacency matrix A, said adjacency matrix having a plurality of entries, Aᵢⱼ wherein:
i and j are among said plurality of sites;
Aᵢⱼ=r if said sites, i, j are connected;
Aᵢⱼ=0 otherwise; and
r is a positive number;
code to compute the transpose matrix A^{T} of said adjacency matrix A; and
code to compute the nth eigenvector X⁽ⁿ⁾ of a matrix product of said transpose matrix and said adjacency matrix, A^{T} A for determining an authority value of said plurality of sites, wherein n is a natural number.

11. Computer executable software code stored on a computer readable medium, the code for detecting at least one emergent concept among a plurality of sites as in claim 10, the code further comprising:
code to compute the nth eigenvector Y⁽ⁿ⁾ of a matrix product of said adjacency matrix and said transpose matrix, A A^{T} for determining a hub value of said plurality of sites.

12. A programmed computer system for detecting at least one emergent concept among a plurality of sites comprising at least one memory having at least one region storing computer executable program code and at least one processor for executing the program code stored in said memory, wherein the program code includes:
code to create at least one adjacency matrix A, said adjacency matrix having a plurality of entries, Aᵢⱼ wherein:
i and j are among said plurality of sites;
Aᵢⱼ=r if said sites, i, j are connected;
Aᵢⱼ=0 otherwise; and
r is a positive number;
code to compute the transpose matrix A^{T} of said adjacency matrix A; and
code to compute the nth eigenvector X⁽ⁿ⁾ of a matrix product of said transpose matrix and said adjacency matrix, A^{T} A for determining an authority value of said plurality of sites, wherein n is a natural number.

13. A programmed computer system for detecting at least one emergent concept among a plurality of sites comprising at least one memory having at least one region storing computer executable program code and at least one processor for executing the program code stored in said memory as in claim 12, wherein the program code further includes:
code to compute the nth eigenvector Y⁽ⁿ⁾ of a matrix product of said adjacency matrix and said transpose matrix, A A^{T} for determining a hub value of said plurality of sites.
